(19) United States
(12) Patent Application Publication
(10) Pub. No.: US 2015/0363709 A1
(43) Pub. Date: Dec. 17, 2015

(54) CLASSIFIER LEARNING DEVICE AND CLASSIFIER LEARNING METHOD

(71) Applicant: NEC CORPORATION, Minato-ku, Tokyo (JP)

(72) Inventors: Toshio KAMEI, Tokyo (JP); Masato ISHII, Tokyo (JP)

(21) Appl. No.: 14/763,702

(22) PCT Filed: Aug. 26, 2013
(86) PCT No.: PCT/JP2013/072665

§ 371 Date: Jul. 27, 2015

(30) Foreign Application Priority Data
Jan. 28, 2013 (JP) 2013-013674

(51) Int. Cl. G06N 99/00; G06F 7/72

(52) U.S. Cl. CPC G06N 99/005; G06F 7/72

(57) ABSTRACT

A classifier learning apparatus (100) includes: an object acquisition unit (101) that acquires a set of reference vectors and assigned category information of the respective reference vectors as a processing object; a specifying unit (102) that specifies an internal nearest neighbor reference vector nearest to a sample vector among the reference vectors assigned to the same category as the sample vector and specifies an external nearest neighbor reference vector nearest to the sample vector among the reference vectors assigned to a category different from that of the sample vector; a calculation unit (103) that calculates an evaluation value of the processing object using a distance between the sample vector and a classification boundary formed by the internal nearest neighbor reference vector and the external nearest neighbor reference vector; and an updating unit (104) that updates an original set of reference vectors and original assigned category information with the processing object based on the evaluation value.

### TECHNICAL FIELD

The present invention relates to a learning technique for a nearest neighbor classifier.

### BACKGROUND ART

As one typical pattern classifier, a nearest neighbor classifier (hereinafter also referred to as an NNC) is known. The NNC holds reference vectors (also referred to as templates or prototypes) classified into categories and outputs a category (class) to which a reference vector having the shortest distance to an input vector is assigned, as a recognition (classification) result for the input vector. In the NNC, by changing reference vectors and categories to which the reference vectors are assigned, a two-class classifier or a multi-class classifier may be configured.

A classification boundary surface of the NNC is a boundary surface of feature spaces that are Voronoi-divided by reference vectors. When the reference vectors that determine the classification boundary surface are learned by using a learning sample previously prepared, a recognition accuracy of the NNC can be enhanced. As a learning method of reference vectors of the NNC, a method referred to as LVQ (Learning Vector Quantization) (see NPL 1 described below) and a method referred to as GLVQ (Generalized Learning Vector Quantization) (see NPL 2 described below), that is an improvement method of the former method, are known. In these learning methods, reference vectors are updated respectively in accordance with their own criteria.

As another pattern classifier, an SVM (Support Vector Machine) is known (see NPL 3 describe below). The SVM learns so as to maximize a distance (margin) between a classification boundary and a learning sample and thereby suppresses over-learning. For example, a linear SVM is applicable to a classification problem of two classes such that a classification boundary surface is planar (see NPL 4 described below). Through this application, learning of the SVM is performed so as to maximize a margin between a classification boundary surface and a learning sample, and therefore classifier having high classification performance may be obtained. PTL 1 described below proposes a method in which a discrimination function utilizing a learning mechanism of an SVM is derived by the use of feature information for the learning and discrimination result information for the learning, and corrects the derived discrimination function by adjusting an influence coefficient indicating an influence degree which is exerted upon the discrimination function by erroneous discrimination feature informationthat a discrimination result is wrong.

As a learning method of a pattern classifier which sets margin maximization as a criterion, an SVM using a kernel technique is also well-known (see NPL 5 described below). Further, PTL 2 described below proposes a voice recognition method using a continuous HMM (Hidden Markov Model) during learning, and using a discrete type HMM during recognition.

### CITATION LIST

### Patent Literature

[PTL 1] Japanese Laid-open Patent Publication No. 2009-186243
[PTL 2] Japanese Laid-open Patent Publication No. 1996(H08)-115099

### Non Patent Literature

[NPL 1] T. Kohonen, “The Neural Phonetic Typewriter”, IEEE Computer, Vol. 21, No. 3, pp. 11-22, 1988
[NPL 2] A. Sato and K. Yamada, “Generalized Learning Vector Quantization”, Advances in Neural Information Processing Systems 8, 423-429, 1996
[NPL 3] R. O. Duda and P. E. Hart and D. G. Stork, Japanese translation of “Pattern Classification”, New Technology Communications, Inc., pp. 256-257, 2001
[NPL 4] R.-E. Fan, K.-W. Chang, X.-R. Wang, C.-J. Hsieh and C.-J. Lin, “LIBLINEAR: a library for linear classification”, Journal of Machine Learning Research, Vol. 9, pp. 1871-1874, 2008
[NPL 5] Chi-Chung Chang and Chih-Jen Lin, “LIBSVM: a library for support vector machines”, ACM Transactions on Intelligent Systems and Technology, Vol. 2, No. 3, Article 27, 2011

### SUMMARY OF INVENTION

### Technical Problem

However, in the aforementioned learning methods such as LVQ and GLVQ, a phenomenon referred to as over-learning occurs, and a classification accuracy of an NNC may be deteriorated. This is because it is not guaranteed that a margin between a classification boundary and a learning sample of the NNC is maximized. Further, the aforementioned SVM is a method for learning a plane to be a classification boundary, and therefore the SVM may not be applicable to learning of reference vectors of the NNC. Likewise, the aforementioned SVM using a kernel technique may also not be applicable to learning of reference vectors of the NNC.

Thus, it is not possible for the aforementioned methods to execute learning which sets margin maximization as a criterion, with regard to the NNC, and therefore it is difficult to suppress over-learning. As a result, it is difficult to enhance a classification accuracy of the NNC.

The present invention has been achieved in view of these circumstances. An objective of the present invention is to provide a learning technique of reference vectors of an NNC that is capable of enhancing classification accuracy.

### Solution to Problem

To solve the aforementioned problem, each aspect of the present invention employs the following configuration respectively.

A first aspect relates to a classifier learning apparatus. The classifier learning apparatus according to the first aspect includes: an object acquisition unit that acquires a set of reference vectors and assigned category information of the respective reference vectors as a processing object; a specifying unit that specifies an internal nearest neighbor reference vector nearest to a sample vector from among the reference vectors of the processing object assigned to the same category as the sample vector and specifies an external nearest neighbor reference vector nearest to the sample vector from among the reference vectors of the processing object assigned to a category different from the sample vector; a calculation unit that calculates an evaluation value of the processing object by using a distance between the sample vector and a classification boundary formed by the internal nearest neighbor reference vector and the external nearest neighbor reference vector; and an updating unit that updates an original set of reference vectors and originally assigned category information with the processing object based on the evaluation value of the processing object calculated by the calculation unit.

A second aspect of the present invention relates to a classifier learning method. The classifier learning method according to the second aspect is executed by at least one computer and includes: acquiring a set of reference vectors and assigned category information of the respective reference vectors as a processing object; specifying an internal nearest neighbor reference vector nearest to a sample vector from among the reference vectors of the processing object assigned to the same category as the sample vector; specifying an external nearest neighbor reference vector nearest to the sample vector from among the reference vectors of the processing object assigned to a category different from the sample vector; calculating an evaluation value of the processing object by using a distance between the sample vector and a classification boundary formed by the internal nearest neighbor reference vector and the external nearest neighbor reference vector; and updating an original set of reference vectors and originally assigned category information by using the processing object based on the calculated evaluation value of the processing object.

Another aspect of the present invention may be a program that causes at least one computer to execute the method of the second aspect or may be a computer-readable recording medium recorded with such a program. This recording medium includes a non-transitory tangible medium.

### Advantageous Effects of Invention

The aforementioned respective aspects can provide a learning technique for reference vectors of an NNC capable of enhancing classification accuracy.

### BRIEF DESCRIPTION OF DRAWINGS

The aforementioned object and other objects as well as features and advantages will become more apparent from the following description of suitable exemplary embodiments and the following drawings that accompany the exemplary embodiments.

FIG. 1 is a diagram conceptually illustrating a configuration example of a classifier learning apparatus according to an exemplary embodiment of the present invention.

FIG. 2 is a diagram conceptually illustrating a hardware configuration example of a nearest neighbor classifier learning apparatus (NNC learning apparatus) in a first exemplary embodiment.

FIG. 3 is a diagram conceptually illustrating a processing configuration example of the nearest neighbor classifier learning apparatus (NNC learning apparatus) in the first exemplary embodiment.

FIG. 4 is a diagram conceptually illustrating a classification boundary of an NNC.

FIG. 5 is a diagram conceptually illustrating a margin of an NNC.

FIG. 6 is a flowchart illustrating an operation example of the nearest neighbor classifier learning apparatus (NNC learning apparatus) in the first exemplary embodiment.

FIG. 7 is a diagram conceptually illustrating a processing configuration example of a nearest neighbor classifier learning apparatus (NNC learning apparatus) in a third exemplary embodiment.

FIG. 8 is a flowchart illustrating an operation example of the nearest neighbor classifier learning apparatus (NNC learning apparatus) in the third exemplary embodiment.

### DESCRIPTION OF EMBODIMENTS

Exemplary embodiments of the present invention will now be described below. The following exemplary embodiments are illustrative, and therefore the present invention is not limited to configurations of the following exemplary embodiments.

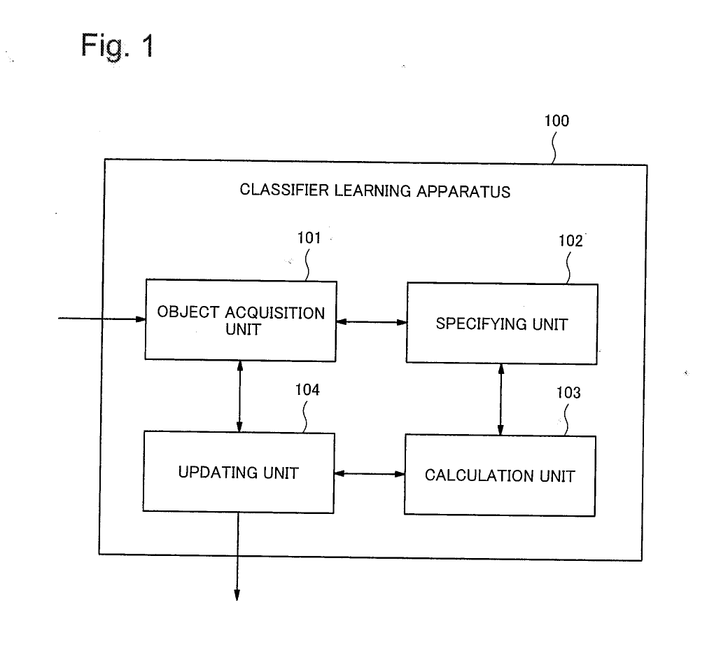

FIG. 1 is a diagram conceptually illustrating a configuration example of a classifier learning apparatus 100 according to an exemplary embodiment of the present invention. As illustrated in FIG. 1, the classifier learning apparatus 100 includes an object acquisition unit 101 that acquires a set of reference vectors and assigned category information of the respective reference vectors as a processing object. Further, the classifier learning apparatus 100 includes a specifying unit 102 that specifies an internal nearest neighbor reference vector which is nearest to a sample vector from among the reference vectors of the processing object assigned to the same category as the sample vector, and specifies an external nearest neighbor reference vector which is nearest to the sample vector from among the reference vectors of the processing object assigned to a category different from the sample vector. Further, the classifier learning apparatus 100 includes a calculation unit 103 that calculates an evaluation value of the processing object by using a distance between a classification boundary formed by the internal nearest neighbor reference vector and the external nearest neighbor reference vector, and the sample vector. Further, the classifier learning apparatus 100 includes an updating unit 104 that updates an original set of reference vectors and originally assigned category information with the processing object based on the evaluation value of the processing object calculated by the calculation unit 103.

The classifier learning apparatus 100 has the same hardware configuration as a nearest neighbor classifier learning apparatus 1 in detailed exemplary embodiments to be described later, for example, and the respective processing units described above are realized by processing a program in the same manner as the nearest neighbor classifier learning apparatus 1.

A classifier learning method according to the exemplary embodiment of the present invention is executed by at least one computer such as the classifier learning apparatus 100 and includes: acquiring a set of reference vectors and assigned category information of the respective reference vectors as a processing object; specifying an internal nearest neighbor reference vector nearest to a sample vector from among the reference vectors of the processing object assigned to the same category as the sample vector; specifying an external nearest neighbor reference vector nearest to the sample vector from among the reference vectors of the processing object assigned to a category different from the sample vector; calculating an evaluation value of the processing object by using a distance between a classification boundary formed by the internal nearest neighbor reference vector and the external nearest neighbor reference vector, and the sample vector; and updating an original set of reference vectors and originally assigned category information with the processing object based on the calculated evaluation value of the processing object. However, the respective steps included in the present classifier learning method may be executed sequentially in random order or may be executed at the same time.

Thus, in the present exemplary embodiment, from a relation between a sample vector and a set of reference vectors acquired as a processing object, an evaluation value of the processing object is calculated, and on the basis of the evaluation value, the set of reference vectors and assigned category information thereof of an NNC are learned. The term “vector” means not only data having a magnitude and a direction but also all of the data consists of a plurality of elements. The respective reference vectors of a set of reference vectors are assigned to categories, and assigned category information indicate categories to which the respective reference vectors are assigned. The “sample vector” refers to learning data having the same number of elements as the respective reference vectors of the processing object and is assigned to a certain category. The processing object and the sample vector may be generated by the classifier learning apparatus 100 or may be acquired from another apparatus or a portable recording medium.

Specifically, an internal nearest neighbor reference vector (hereinafter referred to as an IN-NN reference vector), that is assigned to the same category as a sample vector and is nearest to the sample vector, is specified from among the reference vectors of the processing object. Further, an external nearest neighbor reference vector (hereinafter referred to as an EX-NN reference vector), that is assigned to a category different from the sample vector and is nearest to the sample vector is specified from among the reference vectors of the processing object. An evaluation value of the processing object is calculated by using a distance between a classification boundary formed by the IN-NN reference vector and the EX-NN reference vector, and the sample vector.

Therefore, according to the present exemplary embodiment, it is possible to learn reference vectors of an NNC so as to maximize a distance, i.e. a margin, between a learning sample vector and a classification boundary in a set of reference vectors. As a result, according to the present exemplary embodiment, it is possible to enhance a classification accuracy of the NNC.

The aforementioned exemplary embodiment will be described below in more detail. In the following, as detailed exemplary embodiments, a first exemplary embodiment to a third exemplary embodiment will be exemplified. The following exemplary embodiments are examples in which the classifier learning apparatus 100 and the classifier learning method are applied to a nearest neighbor classifier (NNC) learning apparatus. Applications of the classifier learning apparatus 100, the classifier learning method, and a classifier learned in the following detailed exemplary embodiments are not limited. The classifier is usable in various types of pattern recognition such as character recognition, face recognition, vehicle detection, and voice classification.

### First Exemplary Embodiment

### Configuration of Apparatus

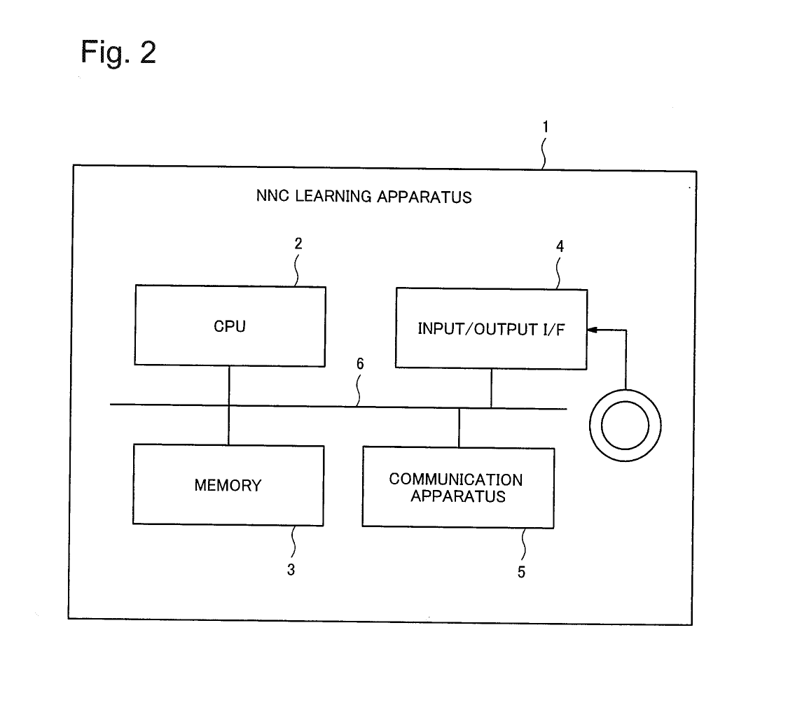

FIG. 2 is a diagram conceptually illustrating a hardware configuration example of a nearest neighbor classifier learning apparatus (hereinafter referred to as an NNC learning apparatus) 1 in a first exemplary embodiment. The NNC learning apparatus 1 in the first exemplary embodiment is a so-called computer, and includes, for example, a CPU (Central Processing Unit) 2, a memory 3, an input/output interface (I/F) 4, a communication apparatus 5, and the like that are connected with each other via a bus 6. The memory 3 may be RAM (Random Access Memory), ROM (Read Only Memory), a hard disk, or a portable storage medium, and the like. The input/output I/F 4 is connectable with a user interface apparatus such as a display apparatus (not illustrated), and an input apparatus (not illustrated). The communication apparatus 5 performs communication with another apparatus via a network (not illustrated). The present exemplary embodiment does not limit the hardware configuration of the NNC learning apparatus 1.

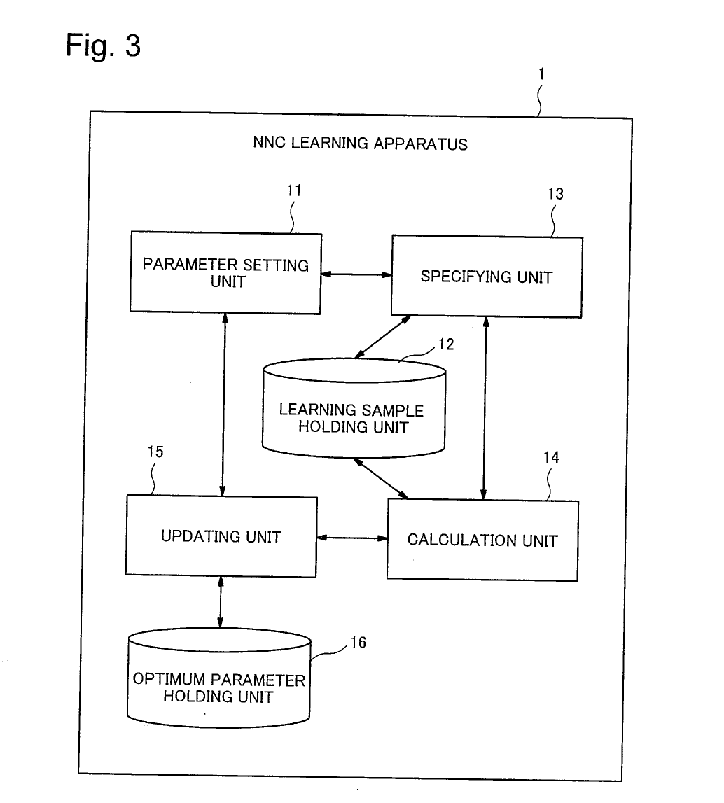

FIG. 3 is a diagram conceptually illustrating a processing configuration example of the NNC learning apparatus 1 in the first exemplary embodiment. The NNC learning apparatus 1 in the first exemplary embodiment includes a parameter setting unit 11, a learning sample holding unit 12, a specifying unit 13, a calculation unit 14, an updating unit 15, an optimum parameter holding unit 16, and the like. These processing units are realized, for example, by executing a program stored in the memory 3 by the CPU 2. The program may be installed from a portable recording medium such as a CD (Compact Disc) and a memory card, or another computer on a network via the input/output I/F 4, and stored in the memory 3.

The parameter setting unit 11 sets a set of reference vectors and assigned category information thereof in an NNC to be a processing object. The processing object set by the parameter setting unit 11 can be expressed by N (N is an integer equal to or greater than 2) reference vectors rᵢ (i is an integer of 1 to N) and categories cᵢ corresponding to the respective reference vectors. The object acquisition unit 101 acquires, for example, such a processing object set by the parameter setting unit 11.

The parameter setting unit 11 sets reference vectors that are parameters of the NNC, for example, by using a technique used for a method such as MDS (Multi-Directional Search), a simplex method, and Alternating Directional Search described in the following reference documents.
Reference Document 1: V. J. Torczon, “On the convergence of the multidirectional search algorithm”, SIAM Journal on Optimization, Vol. 1, pp. 123-145 (1991)
Reference Document 2: N. J. Higham, “Optimization by direct search in matrix computations”, SIAM Journal on Matrix Analysis and Applications, Vol. 14, No. 2, pp. 317-333 (1993)

The parameter setting unit 11 may use, for the reference vectors, a mean vector of a cluster obtained by clustering learning sample vectors by using a K-means method (see Reference Document 3 described below).
Reference Document 3: R. O. Duda and P. E. Hart and D. G. Stork, Japanese translation of “Pattern Classification,” ShinGijutsu Communications K. K., pp. 528-529 (2001)

The learning sample holding unit 12 holds a plurality of learning sample vectors and assigned category information of the respective sample vectors. The information held by the learning sample holding unit 12 can be expresses by M (M is an integer equal to or greater than 2) sample vectors sⱼ (j is an integer of 1 to M) and categories cⱼ corresponding to the respective sample vectors. The sample vectors sⱼ and the reference vectors rᵢ have the same number of elements.

The optimum parameter holding unit 16 holds a set of reference vectors and assigned category information thereof which may be obtained from learning results by the NNC learning apparatus 1, and which are to be optimum parameters of the NNC.

The specifying unit 13 specifies an IN-NN reference vector and an EX-NN reference vector respectively in the same manner as the specifying unit 102 with respect to each of a plurality of sample vectors held in the learning sample holding unit 12. The specifying unit 13 calculates, for example, distances between reference vectors rᵢ and a sample vector sⱼ respectively, and specifies an IN-NN reference vector and an EX-NN reference vector based on the calculated distances. In the present exemplary embodiment, a distance between a sample vector sⱼ and a reference vector rᵢ having the same number of elements is calculated by using a square distance as represented by equation (1) described below.

d(\vec{s}ⱼ,\vec{r}ᵢ)=|\vec{s}ⱼ−\vec{s}ᵢ|² (1)

The calculation unit 14 calculates an evaluation value of a processing object so that when a sample vector is closer to an EX-NN reference vector than to an IN-NN reference vector and a distance between the classification boundary and the sample vector is longer, a lower evaluation is indicated. And also the calculation unit 14 calculates the evaluation value of a processing object so that when the sample vector is closer to the IN-NN reference vector than to the EX-NN reference vector and the distance is longer, a higher evaluation is indicated. When a category of a reference vector to be a nearest neighbor to the sample vector from among all the reference vectors is the same as a category of the sample vector, the sample vector is correctly classified, and therefore it is desirable to maximize a distance (margin) in that case. Therefore, in this case, as described above, the calculation unit 14 calculates the evaluation value of the processing object so as to present a higher evaluation when the distance is longer. On the other hand, when a category of a reference vector to be a nearest neighbor to the sample vector, from among all the reference vectors, is different from the category of the sample vector, the sample vector is incorrectly classified, and therefore it is desirable to minimize a distance (margin) in that case. Therefore, in this case, as described above, the calculation unit 14 calculates the evaluation value of the processing object so as to present a lower evaluation when the distance is longer. The present exemplary embodiment does not limit a calculation method for calculating an evaluation value, by the calculation unit 14, of a processing object from a distance between the classification boundary and a sample vector, when the calculation method may embody such a technical idea as this.

The calculation unit 14 may use, for example, the following calculation method for embodying a technical idea as described above. That is, the calculation unit 14 calculates the distance as a negative value when a sample vector is closer to an EX-NN reference vector than to an IN-NN reference vector. Further, the calculation unit 14 calculates the distance as a positive value when the sample vector is closer to the IN-NN reference vector than to the EX-NN reference vector. Then, the calculation unit 14 calculates an evaluation value of a processing object based on an output value of a sigmoid function which uses the calculated distance as an input. The following equation (2) represents one example of a calculation method for the distance, and the following equation (3) represents a sigmoid function. In the following equation, r_{w} represents an IN-NN reference vector, and r_{b} represents an EX-NN reference vector. A coefficient σ in equation (3) represents a positive constant experimentally set beforehand.

$$\begin{matrix}m ( {\vec{s}}_{j} ) = \frac{{( {\vec{r}}_{w} - {\vec{r}}_{b} )}^{T}}{\vert {\vec{r}}_{w} - {\vec{r}}_{b} \vert} ( {\vec{s}}_{j} - \frac{{\vec{r}}_{w} - {\vec{r}}_{b}}{2} ) & ( 2 ) \\ g ( m ) = \frac{1}{1 + exp ( \frac{- m}{σ} )} & ( 3 )\end{matrix}$$

The calculation unit 14 calculates a total value of evaluation values calculated respectively for each of a plurality of sample vectors held in the learning sample holding unit 12, and uses the total value as a final evaluation value of the processing object. According to the example of equation (2) and equation (3) described above, the calculation unit 14 calculates a final evaluation value J by using the following equation (4).

$$J ( \{ {\vec{r}}_{i} \} ) = {\sum }_{j = 1}^{M} g ( m ( {\vec{s}}_{j} ) ) \qquad ( 4 )$$

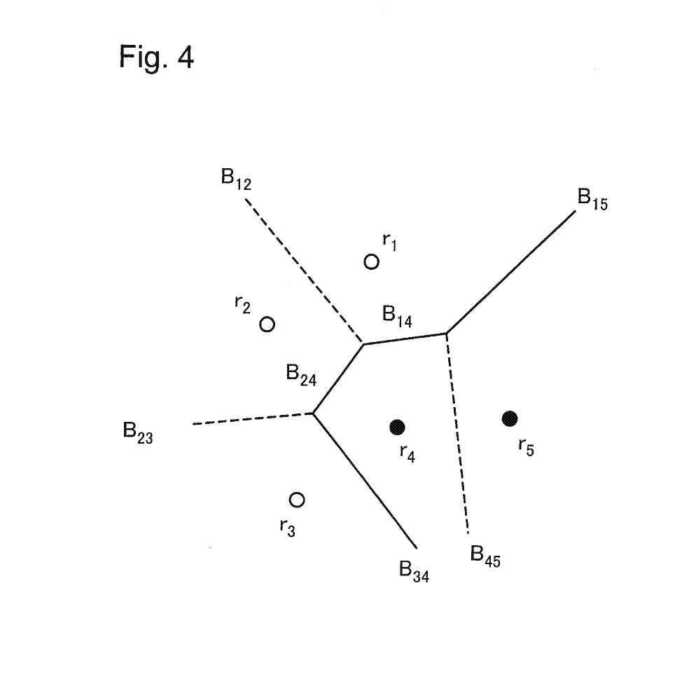

Here, a classification boundary of an NNC will be described with reference to FIG. 4. FIG. 4 is a diagram conceptually illustrating a classification boundary of an NNC. In the example of FIG. 4, reference vectors r₁, r₂, and r₃ are assigned to a category C_{A}, and reference vectors r₄ and r₅ are assigned to a category C_{B}. As illustrated in FIG. 4, a feature space in the NNC is divided into Voronoi areas by the reference vectors. In FIG. 4, boundaries (Voronoi boundaries) of the areas divided by the reference vectors rᵢ are illustrated with solid lines B₁₅, B₁₄, B₂₄, and B₃₄ and dashed lines B₁₂, B₂₃, and B₄₅. The respective boundaries are boundaries of the areas occupied by the respective reference vectors, and a distance between a vector located within an area and a reference vector of the area is minimal. In other words, a nearest neighbor reference vector of the vector located within the area is a reference vector of the area. For example, a nearest neighbor reference vector of an arbitrary vector located within an area surrounded by the dashed line B₂₃, the solid line B₂₄, and the dashed line B₁₂ is the reference vector r₂.

When a square distance is used for an inter-vector distance, a Voronoi boundary is configured by a plane perpendicular to the central point between adjacent reference vectors. For example, the Voronoi boundary of the dashed line B₁₂ is a plane perpendicular to the central point of the reference vector r₁ and the reference vector r₂. However, FIG. 4 is two-dimensionally illustrated, and therefore the Voronoi boundary of the dashed line B₁₂ is expressed as a perpendicular bisector of a line connecting the reference vector r₁ and the reference vector r₂. A classification boundary is formed by a Voronoi boundary between reference vectors which are assigned to different categories, among Voronoi boundaries formed by reference vectors. In the example of FIG. 4, the classification boundary is illustrated by the solid lines B₁₅, B₁₄, B₂₄, and B₃₄.

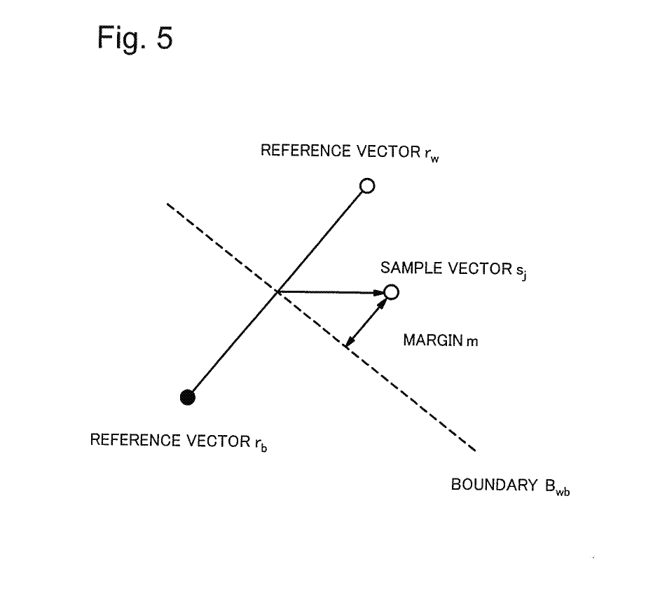

Next, a margin will be described with reference to FIG. 5. FIG. 5 is a diagram conceptually illustrating a margin of an NNC. The margin is a distance between a sample vector sⱼ and a classification boundary nearest to the sample vector sⱼ. The classification boundary nearest to the sample vector sⱼ is a Voronoi boundary B_{wb} configured by a reference vector (IN-NN reference vector) r_{w} nearest to the sample vector sⱼ from among reference vectors assigned to the same category as the sample vector sⱼ, and a reference vector (EX-NN reference vector) r_{b} nearest to the sample vector sⱼ from among reference vectors assigned to a category different from the sample vector sⱼ. A margin m(sⱼ) is a distance from the Voronoi boundary B_{wb} to the sample vector sⱼ. In other words, the margin m(sⱼ) is a distance from the sample vector sⱼ to a plane (classification boundary plane B_{wb}) perpendicular to the central point between the IN-NN reference vector and the EX-NN reference vector, and is calculable by using above described equation (2), or the like.

The updating unit 15 compares a final evaluation value regarding to a set of reference vectors and assigned category information thereof, that are held in the optimum parameter holding unit 16, and a final evaluation value, which is calculated in the calculation unit 14, regarding to a processing object set in the parameter setting unit 11. Then, the updating unit 15 updates the set of reference vectors and the assigned category information thereof held in the optimum parameter holding unit 16 by the set of reference vectors and the assigned category information thereof having a high evaluation value, based on the comparison result. With this manner, the optimum parameter holding unit 16 is not updated, when the final evaluation value of the processing object is smaller than the final evaluation value regarding to the set of reference vectors and the assigned category information thereof held in the optimum parameter holding unit 16.

The NNC learning apparatus 1 causes the parameter setting unit 11 to set new processing objects for a predetermined number of times, and causes the specifying unit 13, the calculation unit 14, and the updating unit 15 to handle each processing object. Consequently, the NNC learning apparatus 1 sequentially updates a set of reference vectors and assigned category information thereof held in the optimum parameter holding unit 16. The NNC learning apparatus 1 may terminate learning processing when information of the optimum parameter holding unit 16 is not updated by the updating unit 15 for a predetermined number of times or more.

### Operation Example

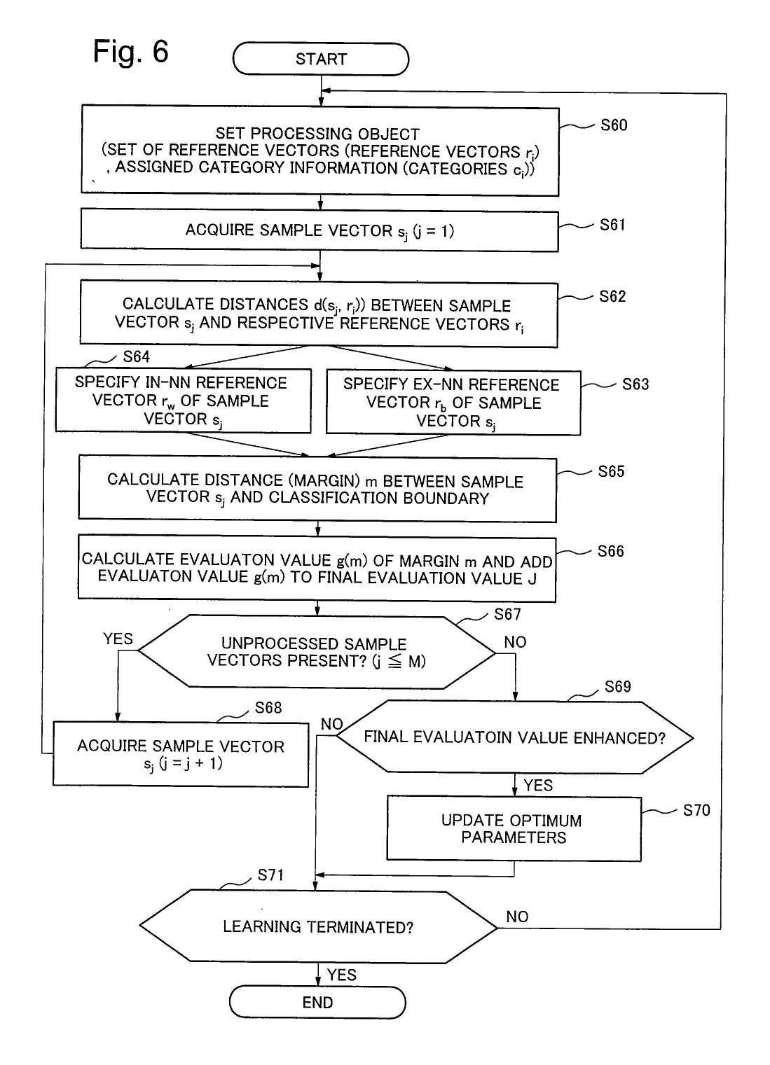

A classifier learning method in the first exemplary embodiment will be described below with reference to FIG. 6. FIG. 6 is a flowchart illustrating an operation example of the NNC learning apparatus 1 in the first exemplary embodiment. In the following description, the NNC learning apparatus 1 is an execution subject of each process, but each processing unit described above included in the NNC learning apparatus 1 may be an execution subject.

The NNC learning apparatus 1 sets a processing object (S60). The processing object is a set of reference vectors and assigned category information thereof that are parameters of an NNC. The NNC learning apparatus 1 sets the processing object by using the method described above for the parameter setting unit 11. The processing object set in (S60) can be expressed by N (N is an integer equal to or greater than 2) reference vectors rᵢ (i is an integer of 1 to N), and categories cᵢ corresponding to the respective reference vectors.

Further, the NNC learning apparatus 1 acquires a sample vector s₁ (S61). All the sample vectors sⱼ can be expressed as M (M is an integer equal to or greater than 2) sample vectors sⱼ (j is an integer of 1 to M) each having the same number of elements as the reference vectors rᵢ. In (S61), one of all the sample vectors sⱼ is acquired.

The NNC learning apparatus 1 respectively calculates distances d(s₁,rᵢ) between the sample vector s₁ and the respective reference vectors rᵢ (S62). In the present exemplary embodiment, the distances d(s₁,rᵢ) are calculated by using the square distance represented by the above equation (1).

The NNC learning apparatus 1 specifies an IN-NN reference vector r_{w} and an EX-NN reference vector r_{b} in regard to the sample vector s₁ based on the distances d(s₁,rᵢ) calculated in (S62) (S63 and S64). The IN-NN reference vector r_{w} is one of the reference vectors rᵢ assigned to the same category as the sample vector s₁, and the EX-NN reference vector r_{b} is one of the reference vectors rᵢ assigned to a category different from the sample vector s₁.

The NNC learning apparatus 1 calculates a margin m(s₁) that is a distance between the sample vector s₁ and a classification boundary formed by the IN-NN reference vector r_{w} and the EX-NN reference vector r_{b} (S65).

The NNC learning apparatus 1 calculates an evaluation value g(m(s₁)) of the margin m(s₁) by inputting the calculated margin m(s₁) to a gain function g(m) such as a sigmoid function (S66).

According to (S65) and (S66), the NNC learning apparatus 1 calculates the evaluation value g(m(s₁)) of the margin m(s₁) so that when the sample vector s₁ is closer to the EX-NN reference vector r_{b} than to the IN-NN reference vector r_{w} and a distance between the classification boundary and the sample vector s₁ is longer, a lower evaluation is indicated, and when the sample vector s₁ is closer to the IN-NN reference vector r_{w} than to the EX-NN reference vector r_{b} and the distance is longer, a higher evaluation is indicated. For example, in (S65), the NNC learning apparatus 1 calculates the margin m(s₁) as a negative value when the sample vector s₁ is closer to the EX-NN reference vector r_{b} than to the IN-NN reference vector r_{w}. And, for example, the NNC learning apparatus 1 calculates the margin m(s₁) as a positive value when the sample vector s₁ is closer to the IN-NN reference vector r_{w} than to the EX-NN reference vector r_{b}. Then, in (S66), the NNC learning apparatus 1 may calculate the evaluation value g(m(s₁)) of the margin m(s₁) by inputting the calculated margin m(s₁) to the sigmoid function g(m).

The NNC learning apparatus 1 adds the calculated evaluation value g(m(s₁)) to a final evaluation value J (S66).

The NNC learning apparatus 1 determines whether unprocessed sample vectors sⱼ are still present (S67). When j is equal to or smaller than M, i.e., unprocessed sample vectors sⱼ are still present (S67: YES), the NNC learning apparatus 1 acquires an unprocessed sample vector sⱼ (j=j+1) (S68). Here, an unprocessed sample vector s₂ is acquired. Hereafter, (S62) to (S66) are executed with respect to the sample vector s₂ as the case of the sample vector s₁. Hereby, in (S66), an evaluation value g(m(s₂)) with respect to the sample vector s₂ is further added to the final evaluation value J. Such processing is executed in regard to all the sample vectors sⱼ respectively.

When a total value of evaluation values g(m(sⱼ)) with respect to all the sample vectors sⱼ is calculated as the final evaluation value J (S67; NO), the NNC learning apparatus 1 determines whether the final evaluation value J is higher than a final evaluation value calculated with respect to an original set of reference vectors and assigned category information thereof (S69). When the final evaluation value j is enhanced (S69: YES), the NNC learning apparatus 1 updates the optimum parameters (S70), with the processing object set in (S60). In other words, when the final evaluation value j is enhanced (S69: YES), the NNC learning apparatus 1 uses the set of reference vectors and the assigned category information thereof set in (S60) as optimum parameters. On the other hand, when the final evaluation value j is not enhanced (S69: NO), the NNC learning apparatus 1 does not update the optimum parameters because the processing object set in (S60) is inferior to the current optimum parameters.

The NNC learning apparatus 1 determines whether learning has been terminated (S71). The termination of learning is determined in accordance with a criterion such that the number of times of repetition of the aforementioned processing has reached to a predetermined number of times, or the final evaluation value J has not been enhanced (S69: NO) even when the aforementioned processing is repeated for a predetermined number of times or more, for example. When the learning is not terminated (S71; NO), the NNC learning apparatus 1 sets a new processing object in (S60), and executes steps succeeding (S60) in regard to the new processing object.

### Operation and Effects in the First Exemplary Embodiment

As described above, in the first exemplary embodiment, in regard to a processing object, a total value of evaluation values of respective margins of a plurality of sample vectors is calculated as a final evaluation value. And optimum parameters of an NNC are updated by the processing object when the final evaluation value is enhanced. The evaluation value of each margin is set as a higher value, when a nearest neighbor reference vector of the sample vector is assigned to the same category as the sample vector, and a distance between a classification boundary and a sample vector is longer. The evaluation value of each margin is also set as a lower value, when the nearest neighbor reference vector of the sample vector is assigned to a category different from the sample vector, and the distance is longer.

Therefore, according to the first exemplary embodiment, it is possible to learn reference vectors of an NNC in accordance with a criterion to maximize margin, and consequently, it is possible to enhance a classification accuracy of the NNC.

### Second Exemplary Embodiment

In the aforementioned first exemplary embodiment, a distance between a sample vector sⱼ and a reference vector rᵢ respectively having the same number of elements was calculated by using a square distance. In the second exemplary embodiment, the distance between the sample vector sⱼ and the reference vector rᵢ is calculated by weighting the square distance. The NNC learning apparatus 1 in the second exemplary embodiment will be described below by focusing on differences to the first exemplary embodiment. In the following description, the same contents as the first exemplary embodiment will be omitted appropriately.

Initially, a relation between a pattern distribution and a classification boundary in an NNC will be described. When patterns are isotropically distributed based on distribution functions of which only center locations are different and the others are the same, a classification boundary thereof forms a plane. It is assumed, for example, a case in which m-th dimensional vectors x of a category C_{A} and a category C_{B} are respectively distributed based on the following two normal distributions p_{A} and p_{B}. In the following equations, Σ represents a variance-covariance matrix, and μ represents a mean vector.

$${p}_{A} = p ( \vec{x} ; {\sum }_{A} , {\vec{μ}}_{A} ) = \frac{1}{{( 2 π )}^{\frac{m}{2}} \vert {\sum }_{A} \vert} exp ( - \frac{1}{2} {( \vec{x} - {\vec{μ}}_{A} )}^{T} {\sum }_{A}^{- 1} ( \vec{x} - {\vec{μ}}_{A} ) )$$

$${p}_{B} = p ( \vec{x} ; {\sum }_{B} , {\vec{μ}}_{B} ) = \frac{1}{{( 2 π )}^{\frac{m}{2}} \vert {\sum }_{B} \vert} exp ( - \frac{1}{2} {( \vec{x} - {\vec{μ}}_{B} )}^{T} {\sum }_{B}^{- 1} ( \vec{x} - {\vec{μ}}_{B} ) )$$

In the equation, when Σ_{A} and Σ_{B} are the same and Σ_{A} and Σ_{B} are an identity matrix I, the category C_{A} and the category C_{B} are represented isotropic normal distributions. When a classification is performed in regard to the distributions, a classification boundary having the least classification error is a boundary in which p_{A} and p_{B} are equal, and is a plane passing through the central point between a mean vector μ_{A} and a mean vector μ_{B} and being orthogonal to a straight line connecting the mean vector μ_{A} and the mean vector μ_{B}. In other words, an ideal NNC that classifies patterns consisting of the distributions p_{A} and p_{B} is a case that a reference vector of the category C_{A} is μ_{A} and a reference vector of the category C_{B} is μ_{B}.

However, when Σ_{A} and Σ_{B} are different from each other, a classification boundary having the least classification error does not always become the plane, which is as described above, passing through the central point between means vectors and being orthogonal to a line segment connecting the means vectors. This is a case of a distribution in which, for example, the respective variances of the category C_{A} and the category C_{B} are Σ_{A}=s_{A}I and Σ_{B}=s_{B}I.

$$\begin{matrix}{p}_{A} = p ( \vec{x} ; {\sum }_{A} , {μ}_{A} , {k}_{A} ) = {k}_{A} exp ( - \frac{1}{2} {( \vec{x} - {\vec{μ}}_{A} )}^{T} {\sum }_{A}^{- 1} ( \vec{x} - {\vec{μ}}_{A} ) ) \\ = {k}_{A} exp ( - \frac{{s}_{A}}{2} {\vert \vec{x} - {\vec{μ}}_{A} \vert}^{2} )\end{matrix}$$

$$\begin{matrix}{p}_{B} = p ( \vec{x} ; {\sum }_{B} , {\vec{μ}}_{B} , {k}_{B} ) = {k}_{B} exp ( - \frac{1}{2} {( \vec{x} - {\vec{μ}}_{B} )}^{T} {\sum }_{B}^{- 1} ( \vec{x} - {\vec{μ}}_{B} ) ) \\ = {k}_{B} exp ( - \frac{{s}_{B}}{2} {\vert \vec{x} - {\vec{μ}}_{B} \vert}^{2} )\end{matrix}$$

A classification boundary having the least error at this time is a plane in which the distributions p_{A} and p_{B} are equal. Logarithm likelihoods of the distributions p_{A} and p_{B} are represented by the following equations.

d_{A}=−2 log p_{A}=s_{A}|\vec{x}−\vec{μ}_{A}|²−2 log k_{A}

d_{B}=−2 log p_{B}=s_{B}|\vec{x}−\vec{μ}_{B}|²−2 log k_{B}

A classification plane in which p_{A} and p_{B} are equal is a classification plane in which d_{A} and d_{B} are equal, and therefore it is understood that this classification plane is a quadratic hypersurface. The aforementioned first exemplary embodiment employs a square distance, and the classification plane becomes a plane (a plane passing through the central point between a reference vector and a reference vector, and being orthogonal to a straight line connecting the reference vectors). Therefore, it is difficult for the classification plane of the first exemplary embodiment to directly express a quadratic hypersurface. Thus, when a square distance is used, it is desirable to approximately express the quadratic hypersurface by using as many reference vectors as possible and setting a plurality of classification planes. However, this causes deterioration of a classification accuracy of an NNC, an increase of the number of reference vectors necessary for the NNC, and a decrease of processing speed.

In regard to such problems, the NNC may be configured with a less number of reference vectors, by modifying a distance function. These problems are able to be resolved by using, for example, the following equation (5) as the distance function. Hereinafter, the following equation (5) will be expressed as a CWP (Compoundly Weighted Power) distance. In this CWP distance, a square distance is weighted by weighting coefficients αᵢ and βᵢ.

αᵢ|\vec{s}ⱼ−\vec{r}ᵢ|²+βᵢ (5)

An ideal NNC in which the CWP distance is used is a case when there is one reference vector in regard to the category C_{A} and the category C_{B} respectively; a reference vector of the category C_{A} is r_{A}=μ_{A} and a distance to the reference vector r_{A} is calculated by using α_{A}=s_{A} and β_{A}=−2 log k_{A}; and a reference vector of the category C_{B} is r_{B}=μ_{B} and a distance to the reference vector r_{B} is calculated by using α_{B}=s_{B} and β_{B}=−2 log k_{B}. In other words, the ideal NNC can be configured with two reference vectors by using the CWP distance instead of the square distance as the distance function.

Further, an NNC suitable for classifying patterns of which variances are equal, and of which distribution of prior probabilities are different, can be also configured by using the following equation (6) as a distance function. Hereinafter, the following equation (6) will be expressed as an AWP (Additively Weighted Power) distance. In this AWP distance, the square distance is weighted by a weighting coefficient βᵢ.

|\vec{s}ⱼ−\vec{r}ᵢ|²+βᵢ (6)

The NNC learning apparatus 1 in the second exemplary embodiment calculates a distance between the sample vector sⱼ and the reference vector rᵢ having the same number of elements by using the CWP distance or the AWP distance.

### Configuration of Apparatus

An apparatus configuration of the NNC learning apparatus 1 in the second exemplary embodiment is the same as the first exemplary embodiment as illustrated in FIG. 2 and FIG. 3. The second exemplary embodiment is different from the first exemplary embodiment, with regard to contents of processing by the processing units, as described below.

The parameter setting unit 11 further sets a weighting coefficient used for calculating an inter-vector distance as the processing object, in addition to a set of reference vectors, and assigned category information thereof. When the CWP distance (equation (5) described above) is used as the distance function, the parameter setting unit 11 further sets weighting coefficients αᵢ and βᵢ as the processing object. Further, when the AWP distance (equation (6) described above) is used as the distance function, the parameter setting unit 11 further sets the weighting coefficient βᵢ as the processing object. The parameter setting unit 11 sets the weighting coefficients αᵢ and βᵢ for each reference vector respectively.

The specifying unit 13 calculates a distance between the sample vector sⱼ and the reference vector rᵢ by using the CWP distance or the AWP distance including the weighting coefficient set in the parameter setting unit 11. Further, a classification boundary is formed as a quadratic hypersurface in the CWP distance, and therefore the specifying unit 13 calculates, for example, a distance m (sⱼ) between the sample vector sⱼ and the classification boundary by using the following equations. In the following equations, the case of “d(sⱼ,r_{w})<d(sⱼ,r_{b})” indicates a case in which the sample vector is closer to an IN-NN reference vector than to an EX-NN reference vector, and “other cases” indicate a case in which the sample vector is closer to the EX-NN reference vector than to the IN-NN reference vector.

$$m ( {\vec{s}}_{j} ) = \{ \begin{matrix}min \vert t ( 2 {\vec{s}}_{j} + \vec{b} ) \vert & ( d ( {\vec{s}}_{j} , {\vec{r}}_{w} ) < d ( {\vec{s}}_{j} , {\vec{r}}_{b} ) ) \\ - min \vert t ( 2 {\vec{s}}_{j} + \vec{b} ) \vert & ( other cases )\end{matrix} \\ \vec{b} = - \frac{2 ( {α}_{w} {\vec{r}}_{w} - {α}_{b} {\vec{r}}_{b} )}{{α}_{w} - {α}_{b}} \\ t = - \frac{1}{2} \pm \frac{1}{2} \sqrt{\frac{{\vert \vec{b} \vert}^{2} + 4 {\vert {\vec{s}}_{j} \vert}^{2} + 4 {\vec{s}}_{j}^{T} \vec{b}}{{\vert \vec{b} \vert}^{2} - 4 c}} \\ c = \frac{( {α}_{w} {\vert {\vec{r}}_{w} \vert}^{2} + {β}_{w} ) - ( {α}_{b} {\vert {\vec{r}}_{b} \vert}^{2} + {β}_{b} )}{{β}_{w} - {β}_{b}}$$

When the AWP distance is used, the specifying unit 13 calculates, for example, a distance m(sⱼ) between the sample vector sⱼ and the classification boundary by using the following equation.

$$m ( {\vec{s}}_{j} ) = \frac{{( {\vec{r}}_{w} - {\vec{r}}_{b} )}^{T}}{\vert {\vec{r}}_{w} - {\vec{r}}_{s} \vert} ( {\vec{s}}_{j} - \frac{{\vec{r}}_{w} + {\vec{r}}_{s}}{2} ) - \frac{{β}_{w} - {β}_{b}}{2 \vert {\vec{r}}_{w} - {\vec{r}}_{b} \vert}$$

The optimum parameter holding unit 16 holds the aforementioned weighting coefficients together with a set of reference vectors and assigned category information thereof as optimum parameters of the NNC.

The updating unit 15 further reflects the weighting coefficients set as the processing object, to the optimum parameter holding unit 16 when updating the optimum parameter holding unit 16.

### Operation Example

A learning method for the classifier in the second exemplary embodiment will be described below with reference to FIG. 6.

In (S60), the NNC learning apparatus 1 further sets a weighting coefficient used for a distance function, as a processing object. In (S62), the NNC learning apparatus 1 respectively calculates a distance d(s₁,rᵢ) between a sample vector s₁ and each of reference vectors rᵢ by using the CWP distance or the AWP distance. In (S70), the NNC learning apparatus 1 updates the optimum parameters with the weighting coefficient, in addition to the set of reference vectors and the assigned category information thereof, as the processing object set in (S60).

### Operation and Effects in the Second Exemplary Embodiment

Thus, in the second exemplary embodiment, the AWP distance or the CWP distance that weights the square distance with the weighting coefficient is used so as to calculate the distance between the sample vector s₁ and each of reference vectors rᵢ. Then, in the second exemplary embodiment, the weighting coefficient used for the distance function is also learned and optimized, in addition to the set of reference vectors and assigned category information thereof, that are parameters of the NNC.

Hereby, learning of reference vectors of an NNC having various pattern distributions becomes possible according to the second exemplary embodiment. In other words, a classification accuracy of the NNC having various pattern distributions can be enhanced according to the second exemplary embodiment. Further, an NNC can be configured with a less number of reference vectors by calculating an inter-vector distance by using the CWP distance or the AWP distance according to the second exemplary embodiment.

### Third Exemplary Embodiment

A pattern classification problem that detects an object such as a face and the like will be exemplified as an example. When a decision about this problem is executed by a pattern classifier, pattern classification is processed as a two-class classification problem of classifying an object (e.g., a face) that is a detection object, and a non-object (e.g., a background) that is not a detection object. In other words, the pattern classifier determines whether it is an object class or a non-object class in regard to input data. As a typical scale of classification accuracy in object detection, there are detection failure rate and excessive detection rate. The detection failure rate is an error rate unable to detect an object which is to be detected, and the excessive detection rate is an error rate detecting a non-object which is not to be detected. In general, the detection failure rate and the excessive detection rate are in a trade-off relation. When the detection failure rate is adjusted to be smaller, the excessive detection rate increases, and on the contrary, when the excessive detection rate is adjusted to be smaller, the detection failure rate increases. In object detection, there is a case in which the excessive detection rate is set at a certain value and detection failure rate is minimized, a case in which the detection failure rate is set at a certain value and excessive detection rate is minimized, or a case in which the excessive detection rate and the detection failure rate are to be the same, and the like.

The NNC learning apparatus 1 in the third exemplary embodiment learns reference vectors of an NNC so as to bring classification accuracy such as detection failure rate, excessive detection rate, or the like close to a specified value. The NNC learning apparatus 1 in the third exemplary embodiment will be described below by focusing on contents different from the first exemplary embodiment and the second exemplary embodiment. In the following description, the same contents as the first exemplary embodiment and the second exemplary embodiment will be omitted appropriately.

### Configuration of Apparatus

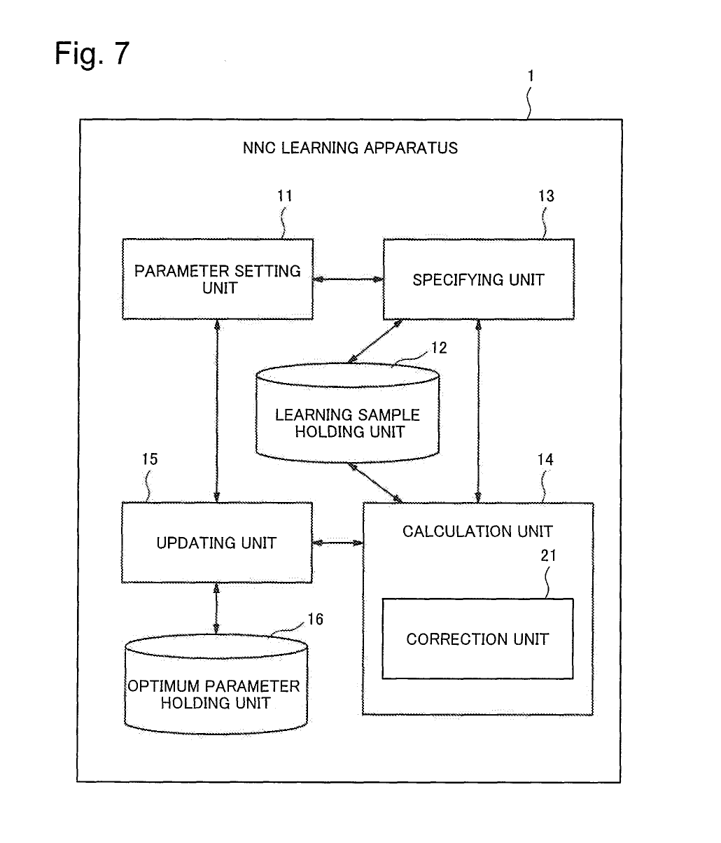

FIG. 7 is a diagram conceptually illustrating a processing configuration example of the NNC learning apparatus 1 in the third exemplary embodiment. In the NNC learning apparatus 1 in the third exemplary embodiment, the calculation unit 14 includes a correction unit 21. The correction unit 21 is also realized, for example, by executing a program stored in the memory 3 by using the CPU 2 as is the case with other processing units. In the example of FIG. 7, an exemplary configuration in which the correction unit 21 exists inside the calculation unit 14 is illustrated, but the correction unit 21 may be realized as a processing unit different from the calculation unit 14.

On the basis of assigned category information of the nearest neighbor reference vector for each of sample vectors sⱼ and assigned category information of each sample vector sⱼ, the correction unit 21 calculates a classification accuracy of a processing object set by the parameter setting unit 11 in regard to the sample vector sⱼ held in the learning sample holding unit 12. The correction unit 21 corrects a final evaluation value of the processing object corresponding to the sample vector sⱼ, by using a correction value corresponding to the calculated classification accuracy and specified classification accuracy information. The specified classification accuracy information may be input by a user by operating an input unit or the like by referring an input screen or the like, or may be acquired via the input/output I/F 4 from a portable recording medium, or from another computer or the like. The specified classification accuracy information indicates a desired classification accuracy, and indicates, for example, a request for a desired detection failure rate, a desired excessive detection rate, or a request for causing a detection failure rate and an excessive detection rate to be the same.

A specific example of the correction unit 21 will be described below. However, the correction unit 21 is not limited only to the specific example as described below. In the following, an embodiment in which an NNC, which is the learning object of the NNC learning apparatus 1, is used for pattern recognition in object detection, will be exemplified.

In learning of the NNC for object detection, a plurality of sample vectors each assigned to either one of an object class and a non-object class are used. A classification error at that time may include two types, that are detection failure and excessive detection. The detection failure means a classification error in which a sample vector of the object class is classified as the non-object class. Therefore, when a nearest neighbor reference vector of a sample vector of the object class is assigned to the non-object class, the sample vector corresponds to the detection failure. On the other hand, the excessive detection means a classification error in which a sample vector of the non-object class is classified as the object class. Therefore, when a nearest neighbor reference vector of a sample vector of the non-object class is assigned to the object class, the sample vector corresponds to the excessive detection.

When a desired detection failure rate is specified as classification accuracy information, the correction unit 21 calculates the number of sample vectors corresponding to the detection failure, for the number of sample vectors held in the learning sample holding unit 12, as a detection failure rate E_{obj}. When a desired excessive detection rate is specified as classification accuracy information, the correction unit 21 calculates the number of sample vectors corresponding to the excessive detection for the number of sample vectors held in the learning sample holding unit 12, as an excessive detection rate E_{bg}. When the calculation unit 14 calculates a margin m(sⱼ) by using equation (2) described above, the correction unit 21 can determine whether the sample vector sⱼ corresponds to detection failure or excessive detection, or the sample vector sⱼ corresponds to classification success, depending on whether a value of the margin m(sⱼ) is positive or negative.

When a final evaluation value J is calculated by the calculation unit 14 as each of the aforementioned exemplary embodiments, the correction unit 21 corrects the final evaluation value J, based on the correction value corresponding to the classification accuracy calculated as described above and specified classification accuracy information. This correction can be represented by the following equations corresponding to the specified classification accuracy information. The following equation (7) is used when the specified classification accuracy information indicates a desired detection failure rate e. The following equation (8) is used when the specified classification accuracy information indicates a desired excessive detection rate e. And the following equation (9) is used when the specified classification accuracy information indicates a request for causing the detection failure rate and the excessive detection rate to be the same. The sign λ in the following each equation is a negative value and is previously set so that an absolute value thereof is sufficiently large compared with a value of J.

J′=J+λ(E_{obj}−e)² (7)

J′=J+λ(E_{bg}−e)² (8)

J′=J+λ(E_{obj}−E_{bg})² (9)

### Operation Example

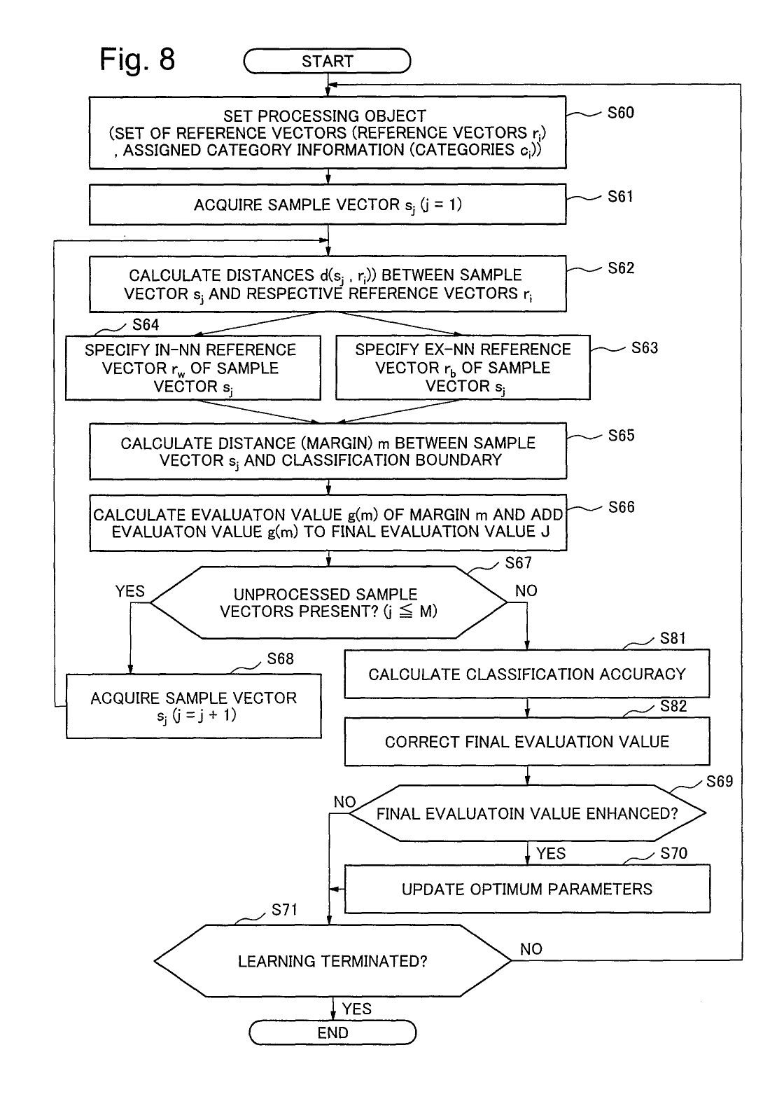

A classifier learning method in the third exemplary embodiment will be described below with reference to FIG. 8. FIG. 8 is a flowchart illustrating an operation example of the NNC learning apparatus 1 in the third exemplary embodiment. In FIG. 8, the same signs as in FIG. 6 are assigned to the same steps as in FIG. 6.

The NNC learning apparatus 1 detects a classification error by processing in (S63), (S64), and (S65). As the classification error, at least either one of detection failure or excessive detection may be detected as mentioned above. Or, as the classification error, it may be detected that a nearest neighbor reference vector of the sample vector sⱼ is an EX-NN reference vector.

When a total value of evaluation values g(m(sⱼ)) with respect to all the sample vectors sⱼ is calculated as the final evaluation value J (S67; NO), the NNC learning apparatus 1 calculates a classification accuracy of a processing object in regard to the sample vector sⱼ based on specified classification accuracy information (S81). For example, The NNC learning apparatus 1 calculates, as the classification accuracy, a ratio of the number of sample vectors sⱼ in which the nearest neighbor reference vector is an EX-NN reference vector, to the number of all the sample vectors sⱼ. As described above, the NNC learning apparatus 1 may calculate the detection failure rate and the excessive detection rate.

The NNC learning apparatus 1 corrects the final evaluation value J by using a correction value corresponding to the classification accuracy calculated in (S81) and specified classification accuracy information (S82). The NNC learning apparatus 1 determines whether a final evaluation value is enhanced based on the corrected final evaluation value (S69).

### Operation and Effects in the Third Exemplary Embodiment

Thus, in the third exemplary embodiment, a classification accuracy of a processing object is calculated in regard to a learning sample vector, and a final evaluation value of the processing object is corrected by using a correction value corresponding to this classification accuracy and specified classification accuracy information. That is, in the third exemplary embodiment, a set of reference vectors and assigned category information thereof are updated so that a classification accuracy of an NNC approaches a specified value. Therefore, according to the third exemplary embodiment, a classification accuracy such as a detection failure rate, an excessive detection rate, and the like can be controlled to become a desired value.

### Modified Example

In each of the aforementioned exemplary embodiments, examples using a square distance, a CWP distance, and an AWP distance as a distance function are illustrated. However, a distance function other than these may be used. In case of a classification of a pattern having a distribution that is not isotropic, for example, the following equation (10) may be used as the distance function. The following equation (10) is expressed as an anisotropic weighting distance. In the following equation, Σ represents a variance-covariance matrix of the sample vector sⱼ and the reference vector rᵢ.

(\vec{s}ⱼ−\vec{r}ᵢ)^{T}Σ⁻¹(\vec{s}ⱼ−\vec{r}ᵢ) (10)

When the anisotropic weighting distance is used, a classification boundary also becomes a quadratic hypersurface, and a distance between the sample vector sj and the quadratic hypersurface can be calculated by using a method described in the following reference document.
Reference Document 4: David Eberly, “Distance from point to a general quadratic curve or a general quadric surface”, http://www.geometrictools.com/Documentation/DistancePointToQuadratic.pdf (1999)

In the aforementioned exemplary embodiments, the NNC learning apparatus 1 includes the parameter setting unit 11, the learning sample holding unit 12, and the optimum parameter holding unit 16. However an apparatus other than the NNC learning apparatus 1 may include the parameter setting unit 11, the learning sample holding unit 12, and the optimum parameter holding unit 16. In this case, the NNC learning apparatus 1 may access the learning sample holding unit 12 and the optimum parameter holding unit 16 via the another apparatus to acquire a processing object from another apparatus.

In a plurality of flowcharts used in the above description, a plurality of steps (processing) are described in order, but an execution order of steps executed in the present exemplary embodiment is not limited to the order of the description. In the present exemplary embodiment, the order of the steps illustrated can be changed within the scope without hindrance from the standpoint of contents. Further, any combination of the aforementioned exemplary embodiments and the modified example can be made as long as contents of them do not conflict.

A part or the whole of the aforementioned exemplary embodiments and the modified example can be specified also as in the following supplemental notes. However, the exemplary embodiments and the modified example are not limited to the following description.

(Supplemental Note 1)

A classifier learning apparatus including:

an object acquisition unit that acquires a set of reference vectors and assigned category information of the respective reference vectors as a processing object;

a specifying unit that specifies an internal nearest neighbor reference vector nearest to a sample vector among the reference vectors of the processing object assigned to the same category as the sample vector and specifies an external nearest neighbor reference vector nearest to the sample vector among the reference vectors of the processing object assigned to a category different from that of the sample vector;

a calculation unit that calculates an evaluation value of the processing object using a distance between a classification boundary formed by the internal nearest neighbor reference vector and the external nearest neighbor reference vector and the sample vector; and an updating unit that updates an original set of reference vectors and original assigned category information with the processing object based on the evaluation value of the processing object calculated by the calculation unit.

(Supplemental Note 2)

The classifier learning apparatus according to Supplemental Note 1, wherein

the calculation unit calculates an evaluation value of the processing object so that a lower evaluation is indicated with an increase in the distance when the sample vector is closer to the external nearest neighbor reference vector than the internal nearest neighbor reference vector and a higher evaluation is indicated with an increase in the distance when the sample vector is closer to the internal nearest neighbor reference vector than the external nearest neighbor reference vector.

(Supplemental Note 3)

The classifier learning apparatus according to Supplemental Note 2, wherein

the calculation unit calculates the distance as a negative value when the sample vector is closer to the external nearest neighbor reference vector than the internal nearest neighbor reference vector, calculates the distance as a positive value when the sample vector is closer to the internal nearest neighbor reference vector than the external nearest neighbor reference vector, and calculates an evaluation value of the processing object based on an output value of a sigmoid function using the calculated distance as an input.

(Supplemental Note 4)

The classifier learning apparatus according to any one of Supplemental Notes 1 to 3, wherein

the specifying unit specifies the internal nearest neighbor reference vector and the external nearest neighbor reference vector for each of a plurality of sample vectors,

the calculation unit calculates a total value of evaluation values respectively calculated for each of the plurality of sample vectors, and

the updating unit compares a total value of evaluation values calculated by the calculation unit for the original set of reference vectors and the original assigned category information, and a total value of evaluation values calculated by the calculation unit for the processing object, and determines whether updating the processing object or not, based on the comparison result.

(Supplemental Note 5)

The classifier learning apparatus according to Supplemental Note 4, wherein

the calculation unit includes

a correction unit that calculates a classification accuracy of the processing object with respect to the plurality of sample vectors based on assigned category information of a nearest neighbor reference vector for each of the plurality of sample vectors and assigned category information of the each sample vector and corrects a total value of evaluation values of the processing object corresponding to the plurality of sample vectors with a correction value corresponding to the calculated classification accuracy and specified classification accuracy information.

(Supplemental Note 6)

The classifier learning apparatus according to any one of Supplemental Notes 1 to 5, wherein

the specifying unit calculates a distance between the sample vector and the reference vector using any one of equation (1), equation (5), equation (6), and equation (10) described above.

(Supplemental Note 7)

The classifier learning apparatus according to Supplemental Note 6, wherein

the object acquisition unit further acquires the weighting coefficient as the processing object,

the specifying unit calculates a distance between the sample vector and the reference vector using equation (5) or equation (6) including the weighting coefficient acquired by the object acquisition unit, and

the updating unit further updates an original weighting coefficient with the weighting coefficient acquired as the processing object.

(Supplemental Note 8)

A classifier learning method executed by at least one computer, the method including:

acquiring a set of reference vectors and assigned category information of the respective reference vectors as a processing object;

specifying an internal nearest neighbor reference vector nearest to a sample vector among the reference vectors of the processing object assigned to the same category as the sample vector;

specifying an external nearest neighbor reference vector nearest to the sample vector among the reference vectors of the processing object assigned to a category different from that of the sample vector;

calculating an evaluation value of the processing object using a distance between the sample vector and a classification boundary formed by the internal nearest neighbor reference vector and the external nearest neighbor reference vector; and

updating an original set of reference vectors and original assigned category information with the processing object based on the calculated evaluation value of the processing object.

(Supplemental Note 9)

The classifier learning method according to Supplemental Note 8, wherein

calculating the evaluation value of the processing object so that a lower evaluation is indicated with an increase in the distance when the sample vector is closer to the external nearest neighbor reference vector than the internal nearest neighbor reference vector, and a higher evaluation is indicated with an increase in the distance when the sample vector is closer to the internal nearest neighbor reference vector than the external nearest neighbor reference vector.

(Supplemental Note 10)

The classifier learning method according to Supplemental Note 9, wherein

in order to calculate the evaluation value, calculating the distance as a negative value when the sample vector is closer to the external nearest neighbor reference vector than the internal nearest neighbor reference vector and calculating the distance as a positive value when the sample vector is closer to the internal nearest neighbor reference vector than the external nearest neighbor reference vector; and

calculating an evaluation value of the processing object based on an output value of a sigmoid function using the calculated distance as an input.

(Supplemental Note 11)

The classifier learning method according to any one of Supplemental Notes 8 to 10, wherein

specifying the internal nearest neighbor reference vector for each of a plurality of sample vectors in order to specify the internal nearest neighbor reference vector;

specifying the external nearest neighbor reference vector for each of a plurality of sample vectors in order to specify the external nearest neighbor reference vector;

calculating a total value of evaluation values respectively calculated for each of the plurality of sample vectors in order to calculate the evaluation value; and

comparing a total value of evaluation values calculated in the calculation unit for the original set of reference vectors and the original assigned category information and a total value of evaluation values calculated in the calculation unit for the processing object and determines whether updating the processing object or not, based on the comparison result, in order to perform the update.

(Supplemental Note 12)

The classifier learning method according to Supplemental Note 11, further including:

calculating a classification accuracy of the processing object with respect to the plurality of sample vectors based on assigned category information of a nearest neighbor reference vector for each of the plurality of sample vectors and assigned category information of the each sample vector; and

correcting a total value of evaluation values of the processing object corresponding to the plurality of sample vectors using a correction value corresponding to the calculated classification accuracy and specified classification accuracy information.

(Supplemental Note 13)

The classifier learning method according to any one of Supplemental Notes 8 to 12, further including

calculating a distance between the sample vector and the reference vector using any one of equation (1), equation (5), equation (6), and equation (10) described above, wherein

in the equations, a vector sⱼ represents the sample vector, a vector rᵢ represents the reference vector, αᵢ and βᵢ represent weighting coefficients corresponding to the reference vector rᵢ, and Σ represents a variance-covariance matrix.

(Supplemental Note 14)

The classifier learning method according to Supplemental Note 13, further including:

acquiring the weighting coefficient as the processing object; and

updating an original coefficient with the weighting coefficient acquired as the processing object based on the calculated evaluation value of the processing object, wherein

a distance between the sample vector and the reference vector is calculated using equation (5) or equation (6) including the weighting coefficient, respectively.

(Supplemental Note 15)

A computer program causing at least one computer to execute the classifier learning method according to any one of Supplemental Notes 8 to 14.

(Supplemental Note 16)

A computer-readable recording medium recorded with the program according to Supplemental Note 15.

This application is based upon and claims the benefit of priority from Japanese patent application No. 2013-013674, filed on Jan. 28, 2013, the disclosure of which is incorporated herein in its entirety by reference.

What is claimed is:

1. A classifier learning apparatus comprising:
an object acquisition unit that acquires a set of reference vectors and assigned category information of the respective reference vectors as a processing object;
a specifying unit that specifies an internal nearest neighbor reference vector nearest to a sample vector among the reference vectors, of the processing object, assigned to the same category as the sample vector and specifies an external nearest neighbor reference vector nearest to the sample vector among the reference vectors, of the processing object, assigned to a category different from that of the sample vector;
a calculation unit that calculates an evaluation value of the processing object using a distance between the sample vector and a classification boundary formed by the internal nearest neighbor reference vector and the external nearest neighbor reference vector; and
an updating unit that updates an original set of reference vectors and original assigned category information with the processing object based on the evaluation value of the processing object calculated by the calculation unit.

2. The classifier learning apparatus according to claim 1, wherein
the calculation unit calculates an evaluation value of the processing object so that a lower evaluation is indicated with an increase in the distance when the sample vector is closer to the external nearest neighbor reference vector than the internal nearest neighbor reference vector, and a higher evaluation is indicated with an increase in the distance when the sample vector is closer to the internal nearest neighbor reference vector than the external nearest neighbor reference vector.

3. The classifier learning apparatus according to claim 2, wherein
the calculation unit calculates the distance as a negative value when the sample vector is closer to the external nearest neighbor reference vector than the internal nearest neighbor reference vector, calculates the distance as a positive value when the sample vector is closer to the internal nearest neighbor reference vector than the external nearest neighbor reference vector, and calculates an evaluation value of the processing object based on an output value of a sigmoid function using the calculated distance as an input.

4. The classifier learning apparatus according to claim 1, wherein
the specifying unit specifies the internal nearest neighbor reference vector and the external nearest neighbor reference vector for each of a plurality of sample vectors,
the calculation unit calculates a total value of evaluation values respectively calculated for each of the plurality of sample vectors, and
the updating unit compares a total value of evaluation values calculated by the calculation unit for the original set of reference vectors and the original assigned category information, and a total value of evaluation values calculated by the calculation unit for the processing object, and determines whether updating the processing object or not, based on the comparison result.

5. The classifier learning apparatus according to claim 4, wherein
the calculation unit comprises
a correction unit that calculates a classification accuracy of the processing object with respect to the plurality of sample vectors based on assigned category information of a nearest neighbor reference vector for each of the plurality of sample vectors and assigned category information of the each sample vector and corrects a total value of evaluation values of the processing object corresponding to the plurality of sample vectors using a correction value corresponding to the calculated classification accuracy and specified classification accuracy information.

6. The classifier learning apparatus according to claim 1, wherein
the specifying unit calculates a distance between the sample vector and the reference vector using any one of the following equation (1), equation (2), equation (3), and equation (4):

|\vec{s}ⱼ−\vec{r}ᵢ|² 1)
αᵢ|\vec{s}ⱼ−\vec{r}ᵢ|²+βᵢ 2)

|\vec{s}ⱼ−\vec{r}ᵢ|²+βᵢ 3)
(\vec{s}ⱼ−\vec{r}ᵢ)^{T}Σ⁻¹(\vec{s}ⱼ−\vec{r}ᵢ) 4)
and in the equations, a vector sⱼ represents the sample vector, a vector rᵢ represents the reference vector, αᵢ and βᵢ represent weighting coefficients corresponding to the reference vector rᵢ, and Σ represents a variance-covariance matrix of the sample vector sⱼ and the reference vector rᵢ.

7. The classifier learning apparatus according to claim 6, wherein
the object acquisition unit further acquires the weighting coefficient as the processing object,
the specifying unit calculates a distance between the sample vector and the reference vector using equation (2) or equation (3) including the weighting coefficient acquired by the object acquisition unit, and
the updating unit further updates an original weighting coefficient with the weighting coefficient acquired as the processing object.

8. A classifier learning method executed by at least one computer, the method comprising:
acquiring a set of reference vectors and assigned category information of the respective reference vectors as a processing object;
specifying an internal nearest neighbor reference vector nearest to a sample vector among the reference vectors, of the processing object, assigned to the same category as the sample vector;
specifying an external nearest neighbor reference vector nearest to the sample vector among the reference vectors, of the processing object, assigned to a category different from that of the sample vector;
a distance between the sample vector and a classification boundary formed by the internal nearest neighbor reference vector and the external nearest neighbor reference vector; and
updating an original set of reference vectors and original assigned category information with the processing object based on the calculated evaluation value of the processing object.

9. A non-transitory computer-readable recording medium that is recorded with a computer program that causes at least one computer to execute a classifier learning method,
the method comprising:
acquiring a set of reference vectors and assigned category information of the respective reference vectors as a processing object;
specifying an internal nearest neighbor reference vector nearest to a sample vector among the reference vectors, of the processing object, assigned to the same category as the sample vector;
specifying an external nearest neighbor reference vector nearest to the sample vector among the reference vectors, of the processing object, assigned to a category different from that of the sample vector;
a distance between the sample vector and a classification boundary formed by the internal nearest neighbor reference vector and the external nearest neighbor reference vector; and
updating an original set of reference vectors and original assigned category information with the processing object based on the calculated evaluation value of the processing object.

10. The classifier learning apparatus according to claim 2, wherein
the specifying unit specifies the internal nearest neighbor reference vector and the external nearest neighbor reference vector for each of a plurality of sample vectors,
the calculation unit calculates a total value of evaluation values respectively calculated for each of the plurality of sample vectors, and
the updating unit compares a total value of evaluation values calculated by the calculation unit for the original set of reference vectors and the original assigned category information, and a total value of evaluation values calculated by the calculation unit for the processing object, and determines whether updating the processing object or not, based on the comparison result.

11. The classifier learning apparatus according to claim 3, wherein
the specifying unit specifies the internal nearest neighbor reference vector and the external nearest neighbor reference vector for each of a plurality of sample vectors,
the calculation unit calculates a total value of evaluation values respectively calculated for each of the plurality of sample vectors, and
the updating unit compares a total value of evaluation values calculated by the calculation unit for the original set of reference vectors and the original assigned category information, and a total value of evaluation values calculated by the calculation unit for the processing object, and determines whether updating the processing object or not, based on the comparison result.

12. The classifier learning apparatus according to claim 2, wherein
the specifying unit calculates a distance between the sample vector and the reference vector using any one of the following equation (1), equation (2), equation (3), and equation (4):

|\vec{s}ⱼ−\vec{r}ᵢ|² 1)
αᵢ|\vec{s}ⱼ−\vec{r}ᵢ|²+βᵢ 2)

|\vec{s}ⱼ−\vec{r}ᵢ|²+βᵢ 3)
(\vec{s}ⱼ−\vec{r}ᵢ)^{T}Σ⁻¹(\vec{s}ⱼ−\vec{r}ᵢ) 4)
and in the equations, a vector sⱼ represents the sample vector, a vector rᵢ represents the reference vector, αᵢ and βᵢ represent weighting coefficients corresponding to the reference vector rᵢ, and Σ represents a variance-covariance matrix of the sample vector sⱼ and the reference vector rᵢ.

13. The classifier learning apparatus according to claim 3, wherein
the specifying unit calculates a distance between the sample vector and the reference vector using any one of the following equation (1), equation (2), equation (3), and equation (4):

|\vec{s}ⱼ−\vec{r}ᵢ|² 1)
αᵢ|\vec{s}ⱼ−\vec{r}ᵢ|²+βᵢ 2)

|\vec{s}ⱼ−\vec{r}ᵢ|²+βᵢ 3)
(\vec{s}ⱼ−\vec{r}ᵢ)^{T}Σ⁻¹(\vec{s}ⱼ−\vec{r}ᵢ) 4)
and in the equations, a vector sⱼ represents the sample vector, a vector rᵢ represents the reference vector, αᵢ and βᵢ represent weighting coefficients corresponding to the reference vector rᵢ, and Σ represents a variance-covariance matrix of the sample vector sⱼ and the reference vector rᵢ.

14. The classifier learning apparatus according to claim 4, wherein
the specifying unit calculates a distance between the sample vector and the reference vector using any one of the following equation (1), equation (2), equation (3), and equation (4):

|\vec{s}ⱼ−\vec{r}ᵢ|² 1)
αᵢ|\vec{s}ⱼ−\vec{r}ᵢ|²+βᵢ 2)

|\vec{s}ⱼ−\vec{r}ᵢ|²+βᵢ 3)
(\vec{s}ⱼ−\vec{r}ᵢ)^{T}Σ⁻¹(\vec{s}ⱼ−\vec{r}ᵢ) 4)
and in the equations, a vector sⱼ represents the sample vector, a vector rᵢ represents the reference vector, αᵢ and βᵢ represent weighting coefficients corresponding to the reference vector rᵢ, and Σ represents a variance-covariance matrix of the sample vector sⱼ and the reference vector rᵢ.

15. The classifier learning apparatus according to claim 5, wherein
the specifying unit calculates a distance between the sample vector and the reference vector using any one of the following equation (1), equation (2), equation (3), and equation (4):

|\vec{s}ⱼ−\vec{r}ᵢ|² 1)
αᵢ|\vec{s}ⱼ−\vec{r}ᵢ|²+βᵢ 2)

|\vec{s}ⱼ−\vec{r}ᵢ|²+βᵢ 3)
(\vec{s}ⱼ−\vec{r}ᵢ)^{T}Σ⁻¹(\vec{s}ⱼ−\vec{r}ᵢ) 4)
and in the equations, a vector sⱼ represents the sample vector, a vector rᵢ represents the reference vector, αᵢ and βᵢ represent weighting coefficients corresponding to the reference vector rᵢ, and Σ represents a variance-covariance matrix of the sample vector sⱼ and the reference vector rᵢ.
